(19) United States
(12) Patent Application Publication
(10) Pub. No.: US 2010/0050757 A1
(43) Pub. Date: Mar. 4, 2010

(54) METHOD AND SYSTEM TO DETERMINE THE EFFICIENCY OF A DIESEL OXIDATION CATALYST

(75) Inventors: Yi Liu, Troy, MI (US); Kevin Dean Sisken, Saline, MI (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Detroit Diesel Corporation, Detroit, MI (US)

(21) Appl. No.: 12/199,882

(22) Filed: Aug. 28, 2008

(51) Int. Cl. G01M 15/04

(52) U.S. Cl. 73/114.75; 702/183

(57) ABSTRACT

A method for determining the efficiency of a diesel oxidation catalyst (DOC) having an inlet and an outlet for the flow of an exhaust gas stream in an exhaust system used in conjunction with an electronic controlled internal combustion engine equipped with an Electronic Control Unit (ECU) having memory, comprising:

determining temperature of the exhaust gas stream at the DOC inlet;

determining temperature of the exhaust gas stream at the DOC outlet;

determining the energy released from the DOC; and

comparing an actual change in temperature of the DOC out to a virtual temperature of the DOC out to determine whether the combustion efficiency of the DOC is below a predetermined value.

### TECHNICAL FIELD OF THE INVENTION

The present invention relates to a method and system to determine the efficiency of a diesel oxidation catalyst and provide an indication to an operator that the efficiency is below a predetermined threshold to allow for servicing of the exhaust gas treatment system in a timely manner.

The present invention further relates to a method and system for using the inlet temperature and outlet temperature of a diesel oxidation catalyst to determine the efficiency of the catalyst and provide a timely alert to an operator when service of the diesel oxidation catalyst is indicated.

These and other aspects of the invention will become apparent upon a reading of the following specification and claims.

### BACKGROUND OF THE INVENTION

The diesel oxidation catalyst (DOC) has been a common component of diesel aftertreatment devices which include particulate filters for new diesel engines since about 2007 and earlier. The efficiency of the DOC affects the regeneration controls of a diesel particulate filter (DPF) which is usually located downstream of the DOC and may also affect the tailpipe hydrocarbon (HC) emissions. Generally a hydrocarbon doser upstream of the DOC provides the HC species and the DOC burns most of the HC to increase the exhaust temperature to a level under which the soot on the DPF can burn clean. Since the DOC typically cannot oxidize 100% of the HC species and its performance deteriorates with aging (and other non-typical events), there is a need for an on-board DOC efficiency calculation to represent a good indication of a failed DOC or potential tail pipe hydrocarbon slip.

### SUMMARY OF THE INVENTION

The present invention utilizes the algorithm described in the following formulas to represent the efficiency of a DOC in an exhaust gas treatment system.

Energy released from DOC can be described as:

\dot{m}_{fuel}·ΔH·η_{doc}=Cₚ·\dot{m}ₑₓₕ·ΔT (1)
where \dot{m}_{fuel}—fuel flow rate from the HC doser to DOC
ΔH—fuel heat content, kJ/kg, constant
η_{doc}—instantaneous DOC efficiency
Cₚ—exhaust specific heat, kJ/kg.C, constant
\dot{m}ₑₓₕ—exhaust flow rate, kg/s
ΔT—temperature increase due to fuel burning, C
   Integration of the above Equation (1) yields the formula:

∫\dot{m}_{fuel}·ΔH·η_{doc}=∫Cₚ·\dot{m}ₑₓₕ·ΔT (2)

The average η̅_{doc} will be:

$${\overline{η}}_{doc} = \frac{\int {C}_{p} \cdot {\dot{m}}_{exh} \cdot Δ T}{\int {\dot{m}}_{fuel} \cdot Δ H} \qquad ( 3 )$$

The ΔT is calculated as the actual DOC temperature minus the virtual DOC temperature. The virtual DOC temperature is the DOC temperature without any combustion of HC in the DOC; the temperature without combustion is the DOC inlet temperature sensed with corrections for heat exchange between the exhaust gas and the DOC substrate and the temperature sensor delay. In Equation 3 set forth above, the fuel flow rate is controlled by the aftertreatment strategy to maintain the desired predetermined DOC out temperature to achieve a controlled DPF regeneration. It is known by the engine control module. The exhaust flow rate is also known based on engine configuration, operating conditions, intake flow input and/or some correction tables. Thus, it can be seen that equation 3 can be calculated on-board the engine/aftertreatment device. Once the calculations are complete, the information is then used in an aftertreatment diagnostic to determine when the DOC combustion efficiency has fallen to a level which requires either correction by the control strategy, for example anticipating that there will be HC slip which will burn in other places in the aftertreatment system, or engine service which might necessitate repair of the DOC by an appropriate means.

In one embodiment of the present invention, the steps for determining the efficiency of the DOC are as follows:
Determining the temperature of the exhaust gas stream at the DOC inlet;
Determining the temperature of the exhaust gas stream at the DOC outlet;
Determining the energy released from DOC according to:

\dot{m}_{fuel}·ΔH·η_{doc}=Cₚ·\dot{m}ₑₓₕ·ΔT (1)
where \dot{m}_{fuel}—fuel flow rate from the HC doser to DOC
ΔH—fuel heat content, kJ/kg, constant
η_{doc}—instantaneous DOC efficiency
Cₚ—exhaust specific heat, kJ/kg.C, constant
\dot{m}ₑₓₕ—exhaust flow rate, kg/s
ΔT—temperature increase due to fuel burning, C
   Integrating Equation (1) over a regeneration event will yield:

∫\dot{m}_{fuel}·ΔH·η_{doc}=Cₚ·\dot{m}ₑₓₕ·ΔT (2)

The average η̅_{doc} will be:

$${\overline{η}}_{doc} = \frac{\int {C}_{p} \cdot {\dot{m}}_{exh} \cdot Δ T}{\int {\dot{m}}_{fuel} \cdot Δ H} \qquad ( 3 )$$

Comparing the actual change in temperature of the DOC to a virtual temperature of the DOC to determine whether the combustion efficiency of the DOC is below a predetermined value; and

Optionally providing an alert to provide an operator notice that the DOC requires servicing.

### BRIEF DESCRIPTION OF THE DRAWINGS

FIG. 1 illustrates a system in accordance with one non-limiting aspect of the present invention.

FIG. 2 is a detailed schematic view of a Diesel Oxidation Catalyst unit, showing the inlet, outlet, doser and attendant sensors.

FIG. 3 illustrates steps in one method according to one embodiment of the present invention.

### DETAILED DESCRIPTION OF THE PREFERRED EMBODIMENT(S)

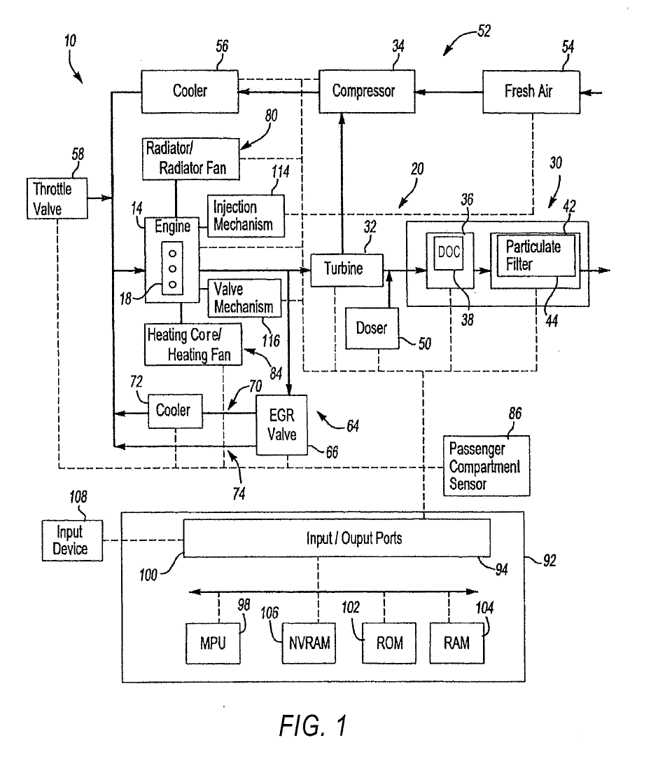

FIG. 1 illustrates a vehicle powertrain system 10 in accordance with one non-limiting aspect of the present invention. The system 10 may provide power for driving any number of vehicles, including on-highway trucks, construction equipment, marine vessels, stationary generators, automobiles, trucks, tractor-trailers, boats, recreational vehicle, light and heavy-duty work vehicles, and the like.

The system 10 may be referred to as an internal combustion driven system wherein fuels, such as gasoline and diesel fuels, are burned in a combustion process to provide power, such as with an spark or compression ignition engine 14. The engine 14 may be a diesel engine that includes a number of cylinders 18 into which fuel and air are injected for ignition as one skilled in the art will appreciate. The engine 14 may be a multi-cylinder compression ignition internal combustion engine, such as a 4, 6, 8, 12, 16, or 24 cylinder diesel engines, for example. It should be noted, however, that the present invention is not limited to a particular type of engine or fuel.

Exhaust gases generated by the engine 14 during combustion may be emitted through an exhaust system 20. The exhaust system 20 may include any number of features, including an exhaust manifold and passageways to deliver the emitted exhaust gases to a particulate filter assembly 30, which in the case of diesel engines is commonly referred to as a diesel particulate filter. Optionally, the system 20 may include a turbocharger proximate the exhaust manifold for compressing fresh air delivery into the engine 14. The turbocharger, for example, may include a turbine 32 and a compressor 34, such as a variable geometry turbocharger (VGT) and/or a turbocompound power turbine. Of course, the present invention is not limited to exhaust systems having turbochargers or the like.

The particulate filter assembly 30 may be configured to capture particulates associated with the combustion process. In more detail, the particulate filter assembly 30 may include a diesel oxidation catalyst (DOC) canister 36, which in includes an DOC 38, and a particulate filter canister 42, which includes a particulate filter 44. The canisters 36, 42 may be separate components joined together with a clamp or other feature such that the canisters 36, 42 may be separated for servicing and other operations. Of course, the present invention is not intended to be limited to this exemplary configuration for the particulate filter assembly 30. Rather, the present invention contemplates the particulate filter assembly including more or less of these components and features. In particular, the present invention contemplates the particulate filter assembly 30 including only the particulate filter 44 and not necessarily the DOC canister 36 or substrate 38 and that the particulate filter 44 may be located in other portions of the exhaust system 20, such as upstream of the turbine 32.

The DOC 38, which for diesel engines is commonly referred to as a diesel oxidation catalyst, may oxidize hydrocarbons and carbon monoxide included within the exhaust gases so as to increase temperatures at the particulate filter 44. The particulate filter 44 may capture particulates included within the exhaust gases, such as carbon, oil particles, ash, and the like, and regenerate the captured particulates if temperatures associated therewith are sufficiently high. In accordance with one non-limiting aspect of the present invention, one object of the particulate filter assembly 30 is to capture harmful carbonaceous particles included in the exhaust gases and to store these contaminates until temperatures at the particulate filter 44 favor oxidation of the captured particulates into a gas that can be discharged to the atmosphere.

The DOC and particulate filter canisters 36, 42 may include inlets and outlets having defined cross-sectional areas with expansive portions therebetween to store the DOC 38 and particulate filter 44, respectively. However, the present invention contemplates that the canisters 36, 42 and devices therein may include any number configurations and arrangements for oxidizing emissions and capturing particulates. As such, the present invention is not intended to be limited to any particular configuration for the particulate filter assembly 30.

To facilitate oxidizing the capture particulates, a doser 50 may be included to introduce fuel to the exhaust gases such that the fuel reacts with the DOC 38 and combusts to increase temperatures at the particulate filter 44, such as to facilitate regeneration. For example, one non-limiting aspect of the present invention contemplates controlling the amount of fuel injected from the doser as a function of temperatures at the particulate filter 44 and other system parameters, such as air mass flow, EGR temperatures, and the like, so as to control regeneration. However, the present invention also contemplates that fuel may be included within the exhaust gases through other measures, such as by controlling the engine 14 to emit fuel with the exhaust gases.

An air intake system 52 may be included for delivering fresh air from a fresh air inlet 54 through an air passage to an intake manifold for introduction to the engine 14. In addition, the system 52 may include an air cooler or charge air cooler 56 to cool the fresh air after it is compressed by the compressor 34. Optionally, a throttle intake valve 58 may be provided to control the flow of fresh air to the engine 14. The throttle valve 58 may be a manually or electrically operated valve, such as one which is responsive to a pedal position of a throttle pedal operated by a driver of the vehicle. There are many variations possible for such an air intake system and the present invention is not intended to be limited to any particular arrangement. Rather, the present invention contemplates any number of features and devices for providing fresh air to the intake manifold and cylinders, including more or less of the foregoing features.

An exhaust gas recirculation (EGR) system 64 may be optionally provided to recycle exhaust gas to the engine 14 for mixture with the fresh air. The EGR system 64 may selectively introduce a metered portion of the exhaust gasses into the engine 14. The EGR system 64, for example, may dilute the incoming fuel charge and lower peak combustion temperatures to reduce the amount of oxides of nitrogen produced during combustion. The amount of exhaust gas to be recirculated may be controlled by controlling an EGR valve 66 and/or in combination with other features, such as the turbocharger. The EGR valve 66 may be a variable flow valve that is electronically controlled. There are many possible configurations for the controllable EGR valve 66 and embodiments of the present invention are not limited to any particular structure for the EGR valve 66.

The EGR system 64 in one non-limiting aspect of the present invention may include an EGR cooler passage 70, which includes an air cooler 72, and an EGR non-cooler bypass 74. The EGR value 66 may be provided at the exhaust manifold to meter exhaust gas through one or both of the EGR cooler passage 70 and bypass 74. Of course, the present invention contemplates that the EGR system 64 may include more or less of these features and other features for recycling exhaust gas. Accordingly, the present invention is not intended to be limited to any one EGR system and contemplates the use of other such systems, including more or less of these features, such as an EGR system having only one of the EGR cooler passage or bypass.

A cooling system 80 may be included for cycling the engine 14 by cycling coolant therethrough. The coolant may be sufficient for fluidly conducting away heat generated by the engine 14, such as through a radiator. The radiator may include a number of fins through which the coolant flows to be cooled by air flow through an engine housing and/or generated by a radiator fan directed thereto as one skilled in the art will appreciated. It is contemplated, however, that the present invention may include more or less of these features in the cooling system 80 and the present invention is not intended to be limited to the exemplary cooling system described above.

The cooling system 80 invention may operate in conjunction with a heating system 84. The heating system 84 may include a heating cone, a heating fan, and a heater valve. The heating cone may receive heated coolant fluid from the engine 14 through the heater valve so that the heating fan, which may be electrically controllable by occupants in a passenger area or cab of a vehicle, may blow air warmed by the heating cone to the passengers. For example, the heating fan may be controllable at various speeds to control an amount of warmed air blown past the heating cone whereby the warmed air may then be distributed through a venting system to the occupants. Optionally, sensors and switches 86 may be included in the passenger area to control the heating demands of the occupants. The switches and sensors may include dial or digital switches for requesting heating and sensors for determining whether the requested heating demand was met. The present invention contemplates that more or less of these features may be included in the heating system and is not intended to be limited to the exemplary heating system described above.

A controller 92, such as an electronic control module or engine control module, may be included in the system 10 to control various operations of the engine 14 and other system or subsystems associated therewith, such as the sensors in the exhaust, EGR, and intake systems. Various sensors may be in electrical communication with the controller via input/output ports 94. The controller 92 may include a microprocessor unit (MPU) 98 in communication with various computer readable storage media via a data and control bus 100. The computer readable storage media may include any of a number of known devices which function as read only memory 102, random access memory 104, and non-volatile random access memory 106. A data, diagnostics, and programming input and output device 108 may also be selectively connected to the controller via a plug to exchange various information therebetween. The device 108 may be used to change values within the computer readable storage media, such as configuration settings, calibration variables, instructions for EGR, intake, and exhaust systems control and others.

The system 10 may include an injection mechanism 114 for controlling fuel and/or air injection for the cylinders 18. The injection mechanism 114 may be controlled by the controller 92 or other controller and comprise any number of features, including features for injecting fuel and/or air into a common-rail cylinder intake and a unit that injects fuel and/or air into each cylinder individually. For example, the injection mechanism 114 may separately and independently control the fuel and/or air injected into each cylinder such that each cylinder may be separately and independently controlled to receive varying amounts of fuel and/or air or no fuel and/or air at all. Of course, the present invention contemplates that the injection mechanism 114 may include more or less of these features and is not intended to be limited to the features described above.

The system 10 may include a valve mechanism 116 for controlling valve timing of the cylinders 18, such as to control air flow into and exhaust flow out of the cylinders 18. The valve mechanism 116 may be controlled by the controller 92 or other controller and comprise any number of features, including features for selectively and independently opening and closing cylinder intake and/or exhaust valves. For example, the valve mechanism 116 may independently control the exhaust valve timing of each cylinder such that the exhaust and/or intake valves may be independently opened and closed at controllable intervals, such as with a compression brake. Of course, the present invention contemplates that the valve mechanism may include more or less of these features and is not intended to be limited to the features described above.

In operation, the controller 92 receives signals from various engine/vehicle sensors and executes control logic embedded in hardware and/or software to control the system 10. The computer readable storage media may, for example, include instructions stored thereon that are executable by the controller 92 to perform methods of controlling all features and sub-systems in the system 10. The program instructions may be executed by the controller in the MPU 98 to control the various systems and subsystems of the engine and/or vehicle through the input/output ports 94. In general, the dashed lines shown in FIG. 1 illustrate the optional sensing and control communication between the controller and the various components in the powertrain system. Furthermore, it is appreciated that any number of sensors and features may be associated with each feature in the system for monitoring and controlling the operation thereof.

In one non-limiting aspect of the present invention, the controller 92 may be the DDEC controller available from Detroit Diesel Corporation, Detroit, Mich. Various other features of this controller are described in detail in a number of U.S. patents assigned to Detroit Diesel Corporation. Further, the controller may include any of a number of programming and processing techniques or strategies to control any feature in the system 10. Moreover, the present invention contemplates that the system may include more than one controller, such as separate controllers for controlling system or sub-systems, including an exhaust system controller to control exhaust gas temperatures, mass flow rates, and other features associated therewith. In addition, these controllers may include other controllers besides the DDEC controller described above.

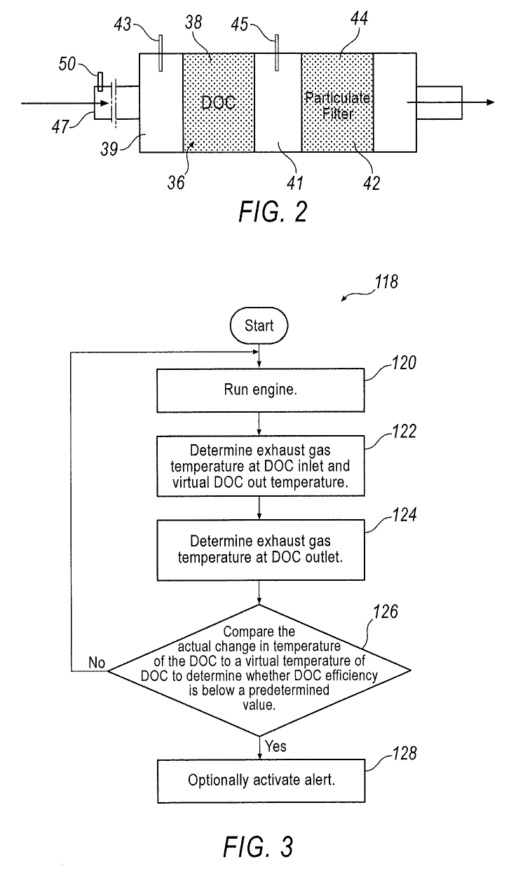

FIG. 2. is a detailed view of the DOC 38 of FIG. 1, showing, more detail one embodiment of its construction. Specifically, canister 36 contains Diesel Oxidation Catalyst 38, in close proximity to the Diesel Particulate Filter (DPF). The DOC has an inlet 39 and an outlet 41, through which the exhaust gas 47 flows. The inlet is equipped with a temperature sensor 43, that is in electronic communication with the on board electronic control unit (ECU). Similarly the outlet is equipped with a temperature sensor 45 in electronic communication with the ECU. In operation, the exhaust gas flow 47 enters the DOC, where it may be subjected to combustion at the DOC, when maybe facilitated by the doser 50. The doser 50 injects hydrocarbons (HC) i.e., fuel, into the exhaust flow stream 47 at controllable times to facilitate clean operation of the engine and the exhaust gas treatment system, and the heat at the DOC causes the mixture to ignite, thereby combusting excess hydrocarbons from the exhaust stream. The heated exhaust gas exits the DOC at the outlet, and another temperature sensor senses the temperature of the exhaust gas flow. The heated temperature then passes to the DPF and is treated and exhausted to the environment.

FIG. 3 is a schematic of one method 118 according to the present invention. Specifically, step 120 is determining the temperature of the exhaust gas flow at the inlet of the DOC.

Specifically step 120 is determining the temperature of the exhaust gas flow at the inlet of the DOC. During operation, the ECU may activate the doser to inject fuel into the exhaust stream to facilitate combustion of unburned hydrocarbons as the exhaust flow stream passes through the DOC. After the exhaust gas stream has passed through the DOC, step 122 is determining the exhaust gas temperature at the DOC outlet. Step 124 is determining the energy released from the exhaust gas temperature through the DOC. In one preferred embodiment, it is usually taken as the difference between the virtual temperature compared to the temperature at the DOC outlet according to:

\dot{m}_{fuel}·ΔH·η_{doc}=Cₚ·\dot{m}ₑₓₕ·ΔT (1)
where \dot{m}_{fuel}—fuel flow rate from the HC doser to DOC
ΔH—fuel heat content, kJ/kg, constant
η_{doc}—instantaneous DOC efficiency
Cₚ—exhaust specific heat, kJ/kg.C, constant
\dot{m}ₑₓₕ—exhaust flow rate, kg/s
ΔT—temperature increase due to fuel burning, C
   Integrating the above Equation (1) yields:

∫\dot{m}_{fuel}·ΔH·η_{doc}=˜Cₚ·\dot{m}ₑₓₕ·ΔT (2)

The average d̅_{doc} will be:

$${\overline{η}}_{doc} = \frac{\int {C}_{p} \cdot {\dot{m}}_{exh} \cdot Δ T}{\int {\dot{m}}_{fuel} \cdot Δ H} \qquad ( 3 )$$

The ΔT is determined as the actual DOC out temperature minus the virtual DOC temperature. The virtual DOC temperate is the DOC out temperature without any combustion in the DOC, the temperature without combustion is the DOC in sensed temperature with corrections for heat exchange between the exhaust gas and the DOC substrate and the temperature sensor delay. In Equation 3, the fuel flow rate is controlled by the aftertreatment strategy to maintain the desired predetermined DOC out temperature to achieve a controlled DPF regeneration. In any engine operating condition the described predetermined DOC out temperature is stored in memory in the Electronic Control Unit. The exhaust flow rate is also known based on engine configuration, operating conditions, intake flow input and some correction tables. Thus, it can be seen that equation 3 is calculated on-board by the engine's controller or aftertreatment device controller. Once the calculations are complete, the information is then used in an aftertreatment diagnostic to determine when the DOC combustion efficiency has fallen to a level which requires either correction by the control strategy, for example anticipating that there will be HC slip which will burn in other places in the aftertreatment system, or engine service which might necessitate repair of the DOC by an appropriate means.

Step 126 is comparing the actual change in temperature of the DOC out to a virtual temperature of the DOC out to determine whether the combustion efficiency of the DOC is below a predetermined value. If yes, optional step 128 is providing an alert to provide an operator notice that the DOC requires servicing. If no, the software loops back to its beginning.

While one embodiment has been discussed, it will be apparent to those skilled in the art that many variations and modifications are possible. In addition, those skilled in the art recognize that the words used in the foregoing specification are words of description, not words of limitation, and the invention is set forth in the appended claims.

What is claimed as new and desired to be protected by Letters Patent of the United States is:

1. A method for determining the efficiency of a diesel oxidation catalyst (DOC) having an inlet and an outlet for the flow of an exhaust gas stream in an exhaust system used in conjunction with an electronic controlled internal combustion engine equipped with an Electronic Control Unit (ECU) having memory, comprising:
determining temperature of the exhaust gas stream at the DOC inlet;
determining temperature of the exhaust gas stream at the DOC outlet;
determining the energy released from the DOC; and
comparing an actual change in temperature of the DOC to a virtual temperature of the DOC to determine whether the combustion efficiency of the DOC is below a predetermined value.

2. The method of claim 1, further including providing an alert to provide an operator notice that the DOC requires servicing.

3. The method of claim 1, wherein the energy released from the DOC is determined according to:
\dot{m}_{fuel}·ΔH·η_{doc}=Cₚ·\dot{m}ₑₓₕ·ΔT (1)
where \dot{m}_{fuel}—fuel flow rate from the HC doser to DOC
ΔH—fuel heat content, kJ/kg, constant
η_{doc}—instantaneous DOC efficiency
Cₚ—exhaust specific heat, kJ/kg.C, constant
\dot{m}ₑₓₕ—exhaust flow rate, kg/s
ΔT—temperature increase due to fuel burning, in degrees C integrating EQU.(1) over a regeneration of the DOC to determine:
∫\dot{m}_{fuel}·ΔH·η_{doc}=∫Cₚ·\dot{m}ₑₓₕ·ΔT (2)
Wherein an average η̅_{doc} is determined according to:
$${\overline{η}}_{doc} = \frac{\int {C}_{p} \cdot {\dot{m}}_{exh} \cdot Δ T}{\int {\dot{m}}_{fuel} \cdot Δ H} \qquad ( 3 )$$

4. The method of claim 1, wherein said virtual temperature is a value processed in memory in the ECU.
